(19) United States
(12) Patent Application Publication
(10) Pub. No.: US 2004/0111740 A1
(43) Pub. Date: Jun. 10, 2004

(54) Broadcasting server system for protecting and managing digital broadcasting contents and an operation method thereof

(76) Inventors: Jong-Won Seok, Daejon (KR); HyeJoo Lee, Daejon (KR); Bum-Suk Choi, Daejon (KR); Jin-Woo Hong, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/724,286

(22) Filed: Nov. 26, 2003

(30) Foreign Application Priority Data
Nov. 28, 2002 (KR) 2002-74671

(51) Int. Cl. H04N 7/167

(52) U.S. Cl. 725/31; 380/201; 380/211

(57) ABSTRACT

Provided is a broadcasting server system that can have many protection and management tools applied thereto, other than conventional access control tools and supplies information on the applied protection and management tools, information on the control over the use of the contents, and information on the purchase of the contents, an operation method thereof, and a computer-readable recording medium for recording a program that implements the method. The broadcasting server system includes: a control unit for generating access control information and a control word based on subscriber information; an additional data generation unit; a watermarking unit; a media encoding unit; an encrypting unit; a multiplexing unit; a re-multiplexing unit; and a scrambling unit.

### FIELD OF THE INVENTION

The present invention relates to a broadcasting server system for protecting and managing digital broadcasting contents, an operation method thereof, and a computer-readable recording medium for recording a program that implements the method. More particularly, this invention provides a broadcasting server system that can have many protection and management tools applied thereto other than conventional access control tools and supplies information on the applied protection and management tools, information on the control over the use of the contents, and information on the purchase of the contents, an operation method thereof, and a computer-readable recording medium for recording a program that implements the method.

### DESCRIPTION OF RELATED ART

Digitalization of broadcasting environments made it possible to provide diverse kinds of services to users, while generating some additional requirements. The digitalization of broadcasting environments brings about epoch-making changes in the production, distribution, and consumption structure of broadcasting contents. Digital broadcasting is technological innovation for providing a high-resolution, multi-channel and multi-function service. In the future, it will be developed from current one-way transmission of digital broadcasting contents to data broadcasting and interactive broadcasting environments. Also, since the bandwidth of broadcasting environment is relatively wider than that of the Internet, it is possible to provide high-quality and high-resolution contents.

However, because the digital broadcasting contents can be copied easily, a matter of protecting and managing the contents comes to the front. The development of digitalization and information communication technology will spread the digital contents in various forms, such as on-line database (DB), CD-ROM, DVD and the like, and this will bring about serious copy right piracy problem among ordinary users who can easily process, copy and/or distribute the digital contents.

Conventionally, an access control technology, which is represented by Conditional Access System (CAS), is mainly used to protect and manage broadcasting contents. The access control technology adopts the concept of subscribers in broadcasting and allows only entitled subscribers, who have the authentic right to watch a particular broadcasting program, to receive the particular broadcasting program. The technology includes a series of processes where a digital broadcasting receiver determines whether a user can receive the broadcasting program.

In the access control system, program signals encrypted in a transmitter are transmitted along with entitlement given to an individual receiver or a particular group, and only the subscribers who are entitled to receiving the program can decrypt the encrypted signals with a smart cart in receivers.

FIG. 1 shows a typical broadcasting server system using the access control technology. Referring to FIG. 1, the typical broadcasting server system includes a subscriber database 101, an access control unit 102, a media encoding unit 103, a multiplexer 104, a re-multiplexer 105, and a scrambling unit 10. The restrictive reception system is formed of two independent elements. One is a system for scrambling digital broadcasting signals, and the other is a system for managing entitlement of subscribers.

In a fee-charging broadcasting content, broadcasting signals of the content go through a scrambling process before they are transmitted in order to be protected from unauthorized viewers, who are not entitled to watching the broadcasting content. The scrambling is performed based on a control word (CW). The control word is transmitted in the form of entitlement control message (ECM) together with the scrambled broadcasting signals.

However, if anyone can access to the control word easily, the scrambling of the broadcasting signals is of no use. Therefore, the entitlement control message should be transmitted to manage the access to the control word based on the entitlement of viewers.

In FIG. 1, the access control unit 102 receives subscriber information from the subscriber database 101 and generates ECM and entitlement management message (EMM) for access control. Then, CAT including the EMM information is generated. The CAT follows the standards of a Moving Picture Experts Group (MPEG)-2 system.

Audio and/or video (A/V) data are outputted from the media encoding unit 103 in the form of compressed data. The compressed data are multiplexed in the multiplexer 104 and outputted in the form of transport streams complying with the MPEG-2 system standards. The re-multiplexer 105 receives the CAT, ECM and EMM packets generated in the access control unit 102 and re-multiplexes them.

Finally, the scrambling unit 106 scrambles the broadcasting transport stream using the control word transmitted from the access control unit 102 and outputs them. As digital broadcasting environments adopt services of new concepts for viewers, however, it becomes very hard to protect and manage digital broadcasting contents only with the conventional access control technology. As aforementioned, access controlling allows only entitled subscribers to access to the broadcasting contents.

This technology, however, has no countermeasure against the possible manipulation or distribution of the broadcasting contents that can occur when the access control system is broken and accessed to without authorization. These problems can cause more serious problems due to the digitalization of broadcasting contents and become a big obstacle to digital multi-media industry.

### SUMMARY OF THE INVENTION

It is, therefore, an object of the present invention to provide a broadcasting server system that can have many protection and management tools applied thereto other than conventional access control tools and supplies information on the applied protection and management tools, information on the control over the use of the contents, and information on the purchase of the contents, an operation method thereof, and a computer-readable recording medium for recording a program that implements the method.

In accordance with an aspect of the present invention, there is provided a broadcasting server system for protecting and managing digital broadcasting contents, including: a control unit for generating access control information and a control word based on subscriber information, the access control information including CAT, entitlement control message (ECM) and entitlement management message (EMM); an additional data generation unit for generating additional data including use control metadata, tool information metadata, and content purchase information metadata to protect and manage the digital broadcasting contents; a watermarking unit for receiving an identification of a broadcasting content, which is referred to as a content ID, and the use control metadata, and watermarking an audio/video (A/V) media signal by using the content ID and the use control metadata as watermarks, the use control metadata including copy control information (CCI), broadcasting flag (BF) and retention information (RI); a media encoding unit for compressing the watermarked A/V media signal; an encrypting unit for encrypting the compressed A/V media signal; a multiplexing unit for receiving and multiplexing the compressed and encrypted A/V media signal to thereby output a media transport stream; a re-multiplexing unit for receiving and re-multiplexing the media transport stream, the additional data and the access control information to thereby output a re-multiplexed signal; and a scrambling unit for scrambling the re-multiplexed signal by using the control word.

In accordance with another aspect of the present invention, there is provided a method for operating a broadcasting server system for protecting and managing digital broadcasting contents, the method including the steps of: a) generating access control information and a control word based on subscriber information, the access control information including CAT, ECM and EMM; b) generating additional data including use control metadata, tool information metadata and content purchase information metadata to protect and manage the digital broadcasting contents; c) receiving an identification of a broadcasting content, which is referred to as a content ID, and the use control metadata and watermarking an A/V media signal by using the content ID and the use control metadata as watermarks, the use control metadata including CCI, BF and RI; d) compressing the watermarked A/V media signal; e) encrypting the compressed A/V media signal; f) receiving and multiplexing the compressed and encrypted A/V media signal to thereby output a media transport stream; g) receiving and re-multiplexing the media transport stream, the additional data and the access control information to thereby output a re-multiplexed signal; and h) scrambling the re-multiplexed signal by using the control word.

In accordance with another aspect of the present invention, there is provided a computer-readable recording medium for recording a program that implements a method for operating a broadcasting server system that protects and manages digital broadcasting contents, including the steps of: a) generating access control information and a control word based on subscriber information, the access control information including CAT, ECM and EMM; b) generating additional data including use control metadata, tool information metadata and content purchase information metadata to protect and manage the digital broadcasting contents; c) receiving an identification of a broadcasting content, which is referred to as a content ID, and the use control metadata and watermarking an A/V media signal by using the content ID and the use control metadata as watermarks, the use control metadata including CCI, BF and RI; d) compressing the watermarked A/V media signal; e) encrypting the compressed A/V media signal; f) receiving and multiplexing the compressed and encrypted A/V media signal to thereby output a media transport stream; g) receiving and re-multiplexing the media transport stream, the additional data and the access control information to thereby output a re-multiplexed signal; and h) scrambling the re-multiplexed signal by using the control word.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram illustrating a typical broadcasting server system; and

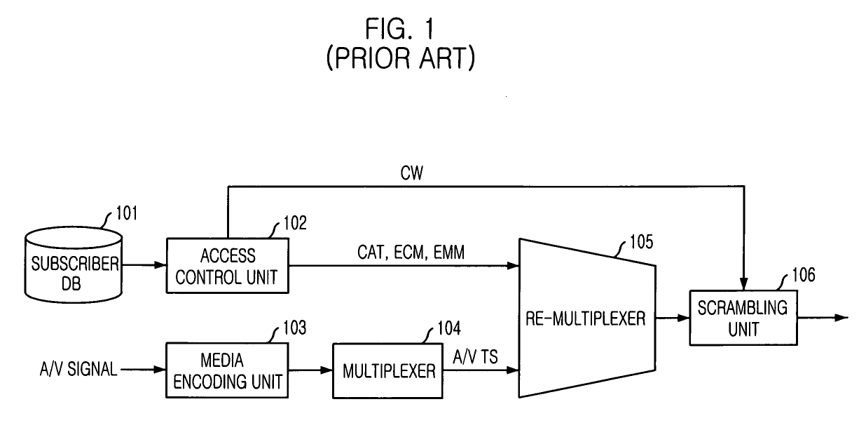

FIG. 2 is a block diagram describing a broadcasting server system for protecting and managing digital broadcasting contents in accordance with an embodiment of the present invention.

### DETAILED DESCRIPTION OF THE INVENTION

Other objects and aspects of the invention will become apparent from the following description of the embodiments with reference to the accompanying drawings, which is set forth hereinafter.

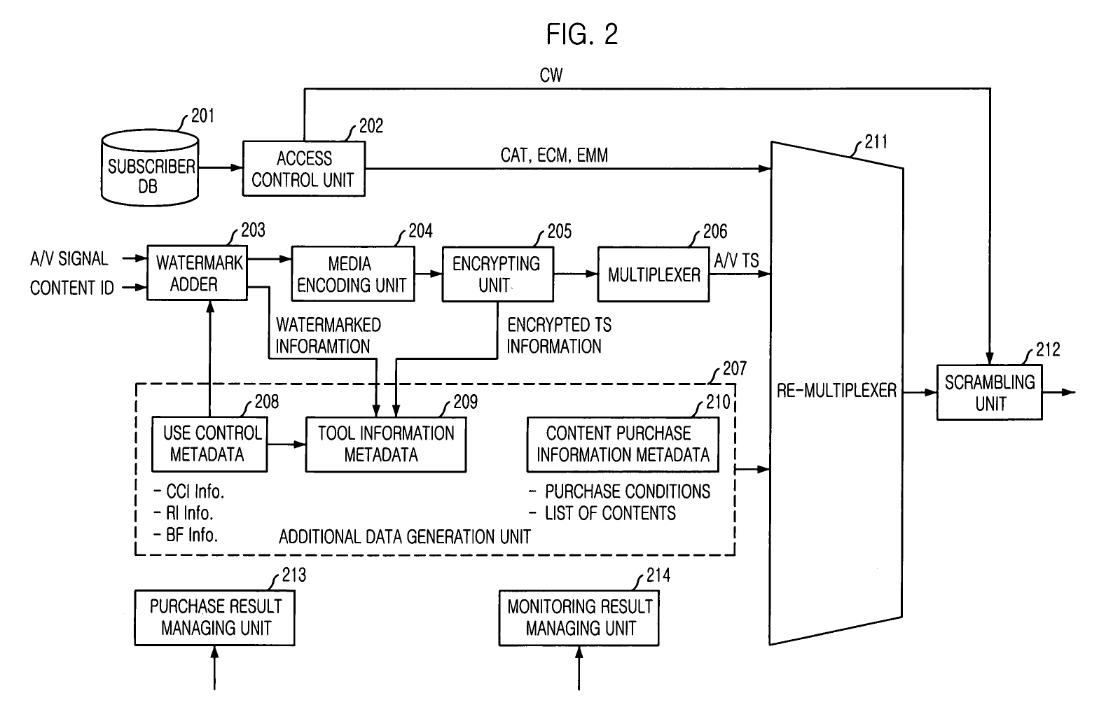

FIG. 2 is a block diagram describing a broadcasting server system for protecting and managing digital broadcasting contents in accordance with an embodiment of the present invention. Referring to FIG. 2, the broadcasting server system for protecting and managing digital broadcasting contents includes a subscriber database (DB) 201, an access control unit 202, a watermark adder 203, a media encoding unit 204, an encrypting unit 205, a multiplexer 206, an additional data generation unit 207, a re-multiplexer 211, a scrambling unit 212, a purchase result managing unit 213 and a monitoring result managing unit 214.

The subscriber database 201 manages subscriber information, and the access control unit 202 generates access control information, e.g., CAT, entitlement control message (ECM) and entitlement management message (EMM), for controlling subscribers' access to broadcasting contents based on the subscriber information.

The watermark adder 203 receives the identification (ID) of a content and the use control metadata which include copy control information (CCI), broadcasting flag (BF) and retention information (RI), and watermarks A/V media signals by using the content ID, CCI, BF and RI as watermarks. The media encoding unit 204 compresses the A/V media signals watermarked in the watermark adder 203.

The encrypting unit 205 encrypts the A/V media signals compressed in the media encoding unit 204. The multiplexer 206 receives and multiplexes the encrypted A/V media signals. The additional data generation unit 207 generates additional data including use control metadata 208, tool information metadata 209 and content purchase information metadata 210 to protect and manage the digital broadcasting contents.

The re-multiplexer 211 receives the media transport streams, which are multiplexed in the multiplexer 206, the additional data and the access control information, and re-multiplexes them. The scrambling unit 212 scrambles the re-multiplexed signals by using a control word (CW) of the access control unit 202.

The broadcasting server system of the present invention further includes the purchase result managing unit 213 for managing the viewer's broadcasting content purchase result and the monitoring result managing unit 214 for managing the monitored result of the broadcasting content.

Broadcasting contents are largely divided into A/V data, the main data, and an additional data. First, the additional data generation unit 207 of the broadcasting server system generates the additional data, e.g., use control metadata 208, tool information metadata 209, and content purchase information metadata 210. The use control metadata 208 include CCI, BF and RI that controls the use of broadcasting contents.

The CCI, BF and RI information are used for controlling the storage and playback of broadcasting contents in a receiver. The CCI has four states: “free copy,” “one copy,” “no more copy,” and “never copy.” When a broadcasting content is transmitted from a transmitter, one of the four states is selected.

The BF is an identifier that tells a content is a broadcasting content. The BF is used to restrict the use of a broadcast content for the other purposes except broadcasting. The RI indicates how long the content can be retained in a hard disk of the receiver. Once the retention time determine in the transmitter is passed, the stored contents is deleted out of the transmitter automatically.

The tool information metadata 209 generate information on tools used for the protection and management of the broadcasting contents, that is, information on the used protection and management tools, information needed for decrypting the broadcasting content the tools are applied to (watermarking information and encrypted transport stream information), information on location the tools are applied to, and information on the kinds of available tools.

FIG. 2 shows an example where watermarking and encryption are used as the protection and management tools. In this case, the tool information metadata 209 include information on the kinds of watermarking tools, information on the kinds of encryption tools, information related to the abstraction of watermarks, information for decrypting the encrypted contents, information on location where the watermarks and the encryption tools can be decrypted in the receiver, information on rules for applying tools in the receiver, and information on the tools that can replace decryption tools in the receiver when the decryption tools do not exist in the receiver or tools themselves.

The content purchase information metadata 210 include purchase conditions and a list of contents that can be purchased when a viewer tries to purchase a content. The purchase result managing unit 213 manages the content purchase result.

The operation of the broadcasting server system of the present invention will be described more in detail. The A/V media signals are transmitted to the watermark adder 203 together with the ID of a broadcasting content, i.e., a content ID. Then, the watermark adder 203 receives the content ID and use control metadata (CCI, BF and RI) of the A/V media data and watermarks the A/V media signals.

The content ID becomes a ground for determining whether a broadcasting content is unlawful, when the broadcasting content is distributed illegally. The monitoring result managing unit 114 receives and manages the monitoring result.

The watermarked A/V media signals are compressed in the media encoding unit 204, encrypted in the encrypting unit 205 by an encryption tool applied thereto, and transmitted to the multiplexer 206. Then, the multiplexer 206 generates multiplexed A/V transport streams.

Subsequently, the re-multiplexer 110 receives and re-multiplexes the additional data (the use control metadata 208, the tool information metadata 209, and the content purchase information metadata 210), the A/V transport streams, and the EMM, ECM and CAT packets which are generated in the control access unit 202. Finally, the scrambling unit 212 scrambles and outputs the broadcasting transport streams by using the control word transmitted from the access control unit 202.

The method of the present invention can be embodied in the form of a program and stored in a computer-readable recording-medium, such as CD-ROMS, RAMs, ROMs, floppy disks, hard disks, and magneto-optical disks.

The technology of the present invention, which is described in the above, can protect and manage broadcasting contents by using watermarking and encrypting tools, other than the convention access control technology. Also, since it includes information on the used protection and management tools, control over the use of a content, and information on purchasing a content, it can protect and manage digital broadcasting contents efficiently in the digital broadcasting environment.

While the present invention has been described with respect to certain preferred embodiments, it will be apparent to those skilled in the art that various changes and modifications may be made without departing from the scope of the invention as defined in the following claims.

What is claimed is:

1. A broadcasting server system for protecting and managing digital broadcasting contents, comprising:
a control means for generating access control information and a control word based on subscriber information, the access control information including CAT, entitlement control message (ECM) and entitlement management message (EMM);
an additional data generation means for generating additional data including use control metadata, tool information metadata, and content purchase information metadata to protect and manage the digital broadcasting contents;
a watermarking means for receiving an identification of a broadcasting content, which is referred to as a content ID, and the use control metadata, and watermarking an audio/video (A/V) media signal by using the content ID and the use control metadata as watermarks, the use control metadata including copy control information (CCI), broadcasting flag (BF) and retention information (RI);
a media encoding means for compressing the watermarked A/V media signal;
an encrypting means for encrypting the compressed A/V media signal;
a multiplexing means for receiving and multiplexing the compressed and encrypted A/V media signal to thereby output a media transport stream;
a re-multiplexing means for receiving and re-multiplexing the media transport stream, the additional data and the access control information to thereby output a re-multiplexed signal; and
a scrambling means for scrambling the re-multiplexed signal by using the control word.

2. The system as recited in claim 1, further comprising:
a purchase result management means for managing broadcasting content purchase result of a user; and
a monitoring result management means for managing broadcasting content monitoring result.

3. The system as recited in claim 1, wherein the content ID is abstracted and used for determining whether a content is an unlawful broadcasting content when the broadcasting content is distributed unlawfully, or the content ID is abstracted and used for determining whether a content that are broadcasted currently is authentic or not after monitoring.

4. The system as recited in claim 1, wherein the use control metadata include the CCI, the BF and the RI, determines from the CCI whether a broadcasting content can be copied, identifies from the BF whether the content is a broadcasting content, and indicates in the RI how long the broadcasting content can be retained being stored in a hard disk of the receiver.

5. The system as recited in claim 4, wherein the tool information metadata include:
protection and management tool information on the protection and management tools used for protecting and managing the broadcasting content;
decrypting information needed for decrypting the broadcasting content to which the protection and management tools are applied, the decrypting information including watermarking information and encrypted transport stream information;
location information on locations to which the protection and management tools should be applied;
replaceable tool information on kinds of tools that can be replaced; and
tools.

6. The system as recited in claim 5, wherein the content purchase information metadata include purchase conditions used when the user purchases the broadcasting content, and a list of contents that can be purchased.

7. A method for operating a broadcasting server system for protecting and managing digital broadcasting contents, the method comprising the steps of:
a) generating access control information and a control word based on subscriber information, the access control information including CAT, entitlement control message (ECM) and entitlement management message (EMM);
b) generating additional data including use control metadata, tool information metadata and content purchase information metadata to protect and manage the digital broadcasting contents;
c) receiving an identification of a broadcasting content, which is referred to as a content ID, and the use control metadata and watermarking an audio/video (A/V) media signal by using the content ID and the use control metadata as watermarks, the use control metadata including copy control information (CCI), broadcasting flag (BF) and retention information (RI);
d) compressing the watermarked A/V media signal;
e) encrypting the compressed A/V media signal;
f) receiving and multiplexing the compressed and encrypted A/V media signal to thereby output a media transport stream;
g) receiving and re-multiplexing the media transport stream, the additional data and the access control information to thereby output a re-multiplexed signal; and
h) scrambling the re-multiplexed signal by using the control word.

8. The method as recited in claim 7, further comprising a step of:
i) managing a broadcasting content purchase result of a user and managing a broadcasting content monitoring result.

9. The method as recited in claim 7, wherein the content ID is abstracted and used for determining whether a content is an unlawful broadcasting content when the broadcasting content is distributed unlawfully, or a content ID is abstracted and used for determining whether the content that are broadcasted currently is authentic or not after monitoring.

10. The method as recited in claim 7, wherein the use control metadata include the CCI, the BF and the RI, determines from the CCI whether a broadcasting content can be copied, identifies from the BF whether the content is a broadcasting content, and indicates in the RI how long the broadcasting content can be retained being stored in a hard disk of the receiver.

11. The method as recited in claim 10, wherein the tool information metadata include:
protection and management tool information on the protection and management tools used for protecting and managing the broadcasting content;
decrypting information needed for decrypting the broadcasting content to which the protection and management tools are applied, the decrypting information including watermarking information and encrypted transport stream information;
location information on locations to which the protection and management tools should be applied;
replaceable tool information on kinds of tools that can be replaced; and
tools.

12. The method as recited in claim 11, wherein the content purchase information metadata include purchase conditions used when the user purchases the broadcasting content, and a list of contents that can be purchased.

13. A computer-readable recording medium for recording a program that implements a method for operating a broadcasting server system that protects and manages digital broadcasting contents, comprising the steps of:
a) generating access control information and a control word based on subscriber information, the access control information including CAT, entitlement control message (ECM) and entitlement management message (EMM);
b) generating additional data including use control metadata, tool information metadata and content purchase information metadata to protect and manage the digital broadcasting contents;
c) receiving an identification of a broadcasting content, which is referred to as a content ID, and the use control metadata and watermarking an audio/video (A/V) media signal by using the content ID and the use control metadata as watermarks, the use control metadata including copy control information (CCI), broadcasting flag (BF) and retention information (RI);
d) compressing the watermarked A/V media signal;
e) encrypting the compressed A/V media signal;
f) receiving and multiplexing the compressed and encrypted A/V media signal to thereby output a media transport stream;
g) receiving and re-multiplexing the media transport stream, the additional data and the access control information to thereby output a re-multiplexed signal; and
h) scrambling the re-multiplexed signal by using the control word.
